(19) United States
(12) Patent Application Publication
(10) Pub. No.: US 2011/0294359 A1
(43) Pub. Date: Dec. 1, 2011

(54) CONNECTOR AND INTERFACE DEVICE

(75) Inventors: Bong-hwan CHO, Suwon-si (KR); Seung-kwon PARK, Yongin-si (KR); Sun-ho YANG, Seoul (KR); Moon-sung NA, Yongin-si (KR)

(73) Assignee: SAMSUNG ELECTRONICS CO., LTD., Suwon-si (KR)

(21) Appl. No.: 13/112,392

(22) Filed: May 20, 2011

Related U.S. Application Data
(60) Provisional application No. 61/348,393, filed on May 26, 2010.

(30) Foreign Application Priority Data
Mar. 3, 2011 (KR) 10-2011-0019119

(51) Int. Cl. H01R 24/60

(52) U.S. Cl. 439/676

(57) ABSTRACT

A connector includes a plurality of contact locations sequentially numbered, and a housing which accommodates the contact locations. The contact locations include a first pair contact location group utilized for a first data transmission, and a second pair contact location group utilized for a second data transmission.

### CROSS-REFERENCE TO RELATED APPLICATIONS

This application claims priority from Korean Patent Application No. 10-2011-0019119 filed Mar. 3, 2011 in the Korean Intellectual Property Office, and the benefit of U.S. Provisional Application No. 61/348,393 filed May 26, 2010 in the U.S. Patent and Trademark Office, the disclosures of which are incorporated herein by reference in their entireties.

### BACKGROUND

1. Field

Apparatuses consistent with exemplary embodiments relate to a connector and an interface, and more particularly, to a connector and an interface device for connecting to a mobile apparatus in various interface manners.

2. Description of the Related Art

A cable connector is a device which transfers electrical signals between two electronic devices. For example, the cable connector can employ a High-Definition Multimedia Interface (HDMI) cable connector, a Universal Serial Bus (USB) cable connector, an audio cable connector, a video cable connector, and so on.

Recent electronic devices, which are connectable to various external devices, include connectors having different standards to connect with the various external devices. For instance, televisions, which are connectable to a digital video disk (DVD) player, a set-top box, a speaker, a computer, a mobile phone, an MP3 player, and a personal music player (PMP), include the HDMI cable connector, the USB cable connector, a Micro-USB, the audio cable connector, and the video cable connector.

However, due to the different standards among these electronic devices, it is not efficient to use a different cable connector per device. Therefore, there is need for a connector which can easily transfer video, audio, and control signals between the plurality of electronic devices.

### SUMMARY

Exemplary embodiments overcome the above disadvantages and other disadvantages not described above. Also, the exemplary embodiments are not required to overcome the disadvantages described above, and an exemplary embodiment may not overcome any of the problems described above.

One or more exemplary embodiments provide a connector and an interface device for connecting a mobile device in various interface manners.

According to an aspect of an exemplary embodiment, there is provided a connector including a plurality of contact locations sequentially numbered; and a housing which accommodates the contact locations, and the contact locations include a first pair contact location group utilized for a first data transmission, and a second pair contact location group utilized for a second data transmission.

The first pair contact location group may include a first pair plus contact location and a first pair minus contact location for differential signaling.

The connector may be compatible with at least one of a Micro-USB connector, a mini USB connector, a USB connector, a Mobile High-definition Link (MHL) connector, and a Digital interface for Video and Audio (DiiVA) connector.

The connector may be at least one of a 5-pin connector and a 6-pin connector.

The contact locations may further include a ground contact location.

The first pair contact location group may be numbered as 1 and 2, the second pair contact location group may be numbered as 3 and 4, and the ground contact location may be numbered as 5.

The connector may be compatible with a Micro-USB connector, a first pair plus contact location of the first pair contact location group may correspond to a VCC contact location of the Micro-USB, a first pair minus contact location of the first pair contact location group may correspond to a DATA− contact location of the Micro-USB, a second pair plus contact location of the second pair contact location group may correspond to a DATA+ contact location of the Micro-USB, a second pair minus contact location of the second pair contact location group may correspond to an ID contact location of the Micro-USB, and the ground contact location may correspond to a GND contact location of the Micro-USB.

The connector may be compatible with a USB connector, a first pair plus contact location of the first pair contact location group may correspond to a VCC contact location of the USB, a first pair minus contact location of the first pair contact location group may correspond to a DATA− contact location of the USB, a second pair plus contact location of the second pair contact location group may correspond to a DATA+ contact location of the USB, and a second pair minus contact location of the second pair contact location group may correspond to a GND contact location of the USB.

The connector may be compatible with an MHL connector, a first pair plus contact location of the first pair contact location group may correspond to a VBUS contact location of the MHL connector, a first pair minus contact location of the first pair contact location group may correspond to an MHL− contact location of the MHL connector, a second pair plus contact location of the second pair contact location group may correspond to an MHL+ contact location of the MHL connector, a second pair minus contact location of the second pair contact location group may correspond to a CBUS contact location of the MHL connector, and the ground contact location may correspond to an MHL GND contact location of the MHL connector.

The contact locations may further include a power contact location for sending power.

The connector may be compatible with a DiiVA connector, the first pair contact location group may correspond to a VLO contact location of the DiiVA connector, the second pair contact location group may correspond to a GND contact location of the DiiVA connector, the ground contact location may correspond to a HL+ contact location of the DiiVA connector, and the power contact location may correspond to a HL− contact location of the DiiVA connector.

According to an aspect of another exemplary embodiment, there is provided an interface device including a plurality of contact locations sequentially numbered; and an acceptor which accommodates the contact locations. The contact locations include a first pair contact location group utilized for a first data transmission, and a second pair contact location group utilized for a second data transmission.

The first pair contact location group may include a first pair plus contact location and a first pair minus contact location for differential signaling.

The acceptor may be at least one of a Micro-USB acceptor, a mini USB acceptor, a USB acceptor, a Mobile High-definition Link (MHL) acceptor, and a Digital interface for Video and Audio (DiiVA) acceptor.

The acceptor may be at least one of a 5-pin acceptor and a 6-pin acceptor.

The contact locations may further include a ground contact location.

The first pair contact location group may be numbered as 1 and 2, the second pair contact location group may be numbered as 3 and 4, and the ground contact location may be numbered as 5.

The acceptor may be compatible with a Micro-USB acceptor, a first pair plus contact location of the first pair contact location group may correspond to a VCC contact location of the Micro-USB, a first pair minus contact location of the first pair contact location group may correspond to a DATA− contact location of the Micro-USB, a second pair plus contact location of the second pair contact location group may correspond to a DATA+ contact location of the Micro-USB, a second pair minus contact location of the second pair contact location group may correspond to an ID contact location of the Micro-USB, and the ground contact location may correspond to a GND contact location of the Micro-USB.

The acceptor may be compatible with a USB acceptor, a first pair plus contact location of the first pair contact location group may correspond to a VCC contact location of the USB, a first pair minus contact location of the first pair contact location group may correspond to a DATA− contact location of the USB, a second pair plus contact location of the second pair contact location group may correspond to a DATA+ contact location of the USB, and a second pair minus contact location of the second pair contact location group may correspond to a GND contact location of the USB.

The acceptor may be compatible with an MHL acceptor, a first pair plus contact location of the first pair contact location group may correspond to a VBUS contact location of the MHL acceptor, a first pair minus contact location of the first pair contact location group may correspond to an MHL− contact location of the MHL acceptor, a second pair plus contact location of the second pair contact location group may correspond to an MHL+ contact location of the MHL acceptor, a second pair minus contact location of the second pair contact location group may correspond to a CBUS contact location of the MHL acceptor, and the ground contact location may correspond to an MHL GND contact location of the MHL acceptor.

The contact locations may further include a power contact location for providing power.

The acceptor may be compatible with a DiiVA acceptor, the first pair contact location group may correspond to a VLO contact location of the DiiVA, the second pair contact location group may correspond to a GND contact location of the DiiVA, the ground contact location may correspond to a HL+ contact location of the DiiVA, and the power contact location may correspond to a HL− contact location of the DiiVA.

The interface device may send and receive a wakeup signal which wakes up from a standby mode, to and from an external device connected.

The first pair contact location group may send and receive the wakeup signal to and from the device.

The wakeup signal may include a start field indicating start of a wakeup instruction, a wakeup mode field indicating a mode of the wakeup, and an ACK field.

The mode of the wakeup may include a plurality of wakeup modes corresponding to a plurality of operation modes of the device respectively, and a charge mode.

The interface device may send and receive power to and from an external device using two or more of the contact locations.

A contact location for sending and receiving the power may be the second pair contact location group.

### BRIEF DESCRIPTION OF THE DRAWINGS

The above and/or other aspects of the exemplary embodiments will become more apparent from the following detailed description when taken in conjunction with the accompanying drawings, in which:

FIG. 1 is a block diagram of a media player device according to an exemplary embodiment;

FIG. 2 is a block diagram of an interface device according to an exemplary embodiment;

FIG. 3 is a detailed diagram of an acceptor of FIG. 2;

FIG. 4 is a diagram of a cable connector according to an exemplary embodiment;

FIG. 5 is a detailed diagram of the connector of FIG. 4;

FIG. 6 is a diagram of a New Interface (NIF) structure according to an exemplary embodiment;

FIG. 7 is a diagram of a Mini/Micro-USB interface;

FIG. 8 is a diagram of a USB interface;

FIG. 9 is a diagram of an MHL interface;

FIG. 10 is a diagram of a DiiVA interface;

FIG. 11 is a diagram of a method for sending and receiving data according to the NIF structure according to an exemplary embodiment;

FIG. 12 is a detailed diagram of a lane structure of FIG. 11;

FIG. 13 is a diagram of a method for waking up the media player device via the NIF according to an exemplary embodiment;

FIG. 14 is a diagram of a wakeup signal according to an exemplary embodiment;

FIG. 15 is a diagram of a wakeup initiation instruction;

FIG. 16 is a diagram of a method of the media player device for charging an external device through the NIF including 6 pins;

FIG. 17 is a diagram of a method of the media player device for charging the external device through the NIF including 5 pins;

FIG. 18 is a diagram of operations of the interface device when the media player device is connected to a device including the Micro-USB interface according to an exemplary embodiment;

FIG. 19 is a diagram of operations of the interface device when the media player device is connected to a device including the NIF according to an exemplary embodiment; and

FIG. 20 is a flowchart of a method for charging the external device connected to the media player device with different interfaces according to an exemplary embodiment.

### DETAILED DESCRIPTION OF EXEMPLARY EMBODIMENTS

Exemplary embodiments are described in greater detail below with reference to the accompanying drawings.

In the following description, like drawing reference numerals are used for the like elements, even in different drawings. The matters defined in the description, such as detailed construction and elements, are provided to assist in a comprehensive understanding of the exemplary embodiments. However, exemplary embodiments can be practiced without those specifically defined matters. Also, well-known functions or constructions are not described in detail since they would obscure the exemplary embodiments with unnecessary detail.

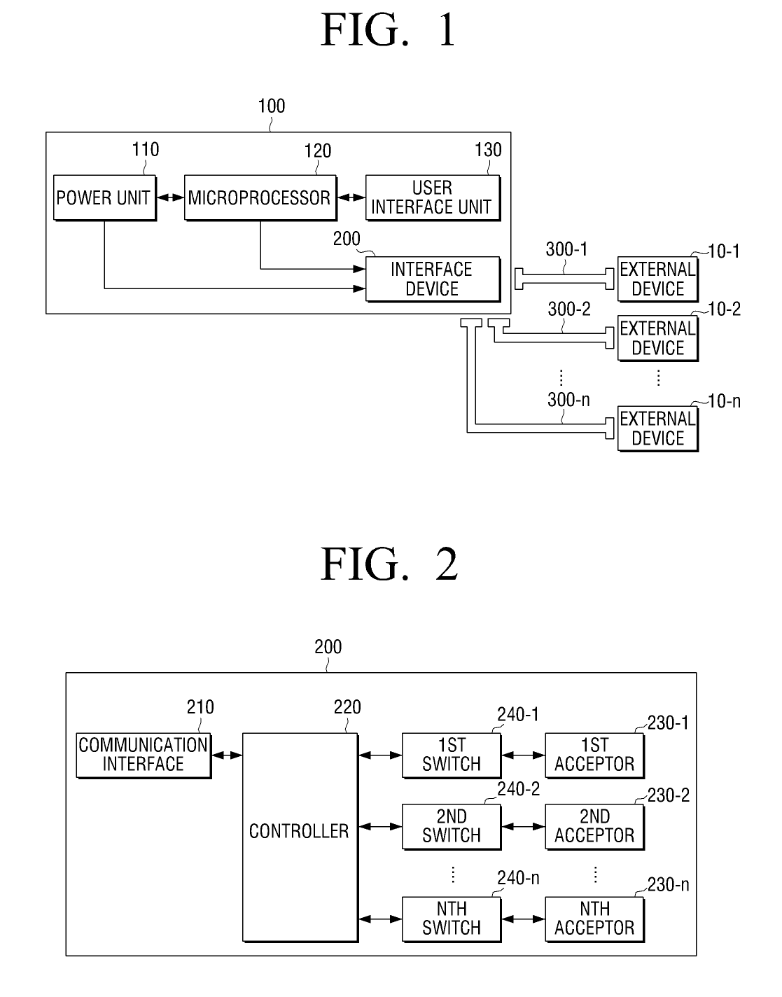

FIG. 1 is a block diagram of a media player device according to an exemplary embodiment.

Referring to FIG. 1, the media player device 100 includes a power unit 110, a microprocessor 120, a user interface unit 130, and an interface device 200.

The media player device 100 is connected to external devices (hereafter, referred to as external devices) 10-1 through 10-n via cable connectors 300-1 through 300-n. The media player device 100 encompasses broadcast receivers such as Digital Television (DTV), DVD player, and set-top box, and personal computers, notebook computers, MP3 players, PMPs, and mobile phones containing various contents. The devices encompass a personal computer, a notebook computer, a MP3 player, a PMP, and a mobile phone, which can operate for a certain time without separate power supply from outside.

The power unit 110 supplies power to the components of the media player device 100. The power unit 110 can be implemented using a Switched Mode Power Supply (SMPS) or a transformer, and a rectifier circuit.

The power unit 110 can output the different power according to an operation state of the media player device 100. For example, when the media player device 100 is in a normal mode, the power unit 110 can output the normal-mode power to supply the power to every component of the media player device 100. When the media player device 100 is in a standby mode, the power unit 110 can output the standby-mode power to supply the power to only some components for the standby. When the media player device 100 works in a charge mode merely to charge the external devices 10-1 through 10-n, the power unit 110 can output the charge-mode power to supply the power to some components for the standby and the external device being charged.

The microprocessor 120 can control the components of the media player device 100. In more detail, when receiving a wakeup signal for the media player device 100 from a user's or from the interface device 200, the microprocessor 120 can control the power unit 110 to output the corresponding power.

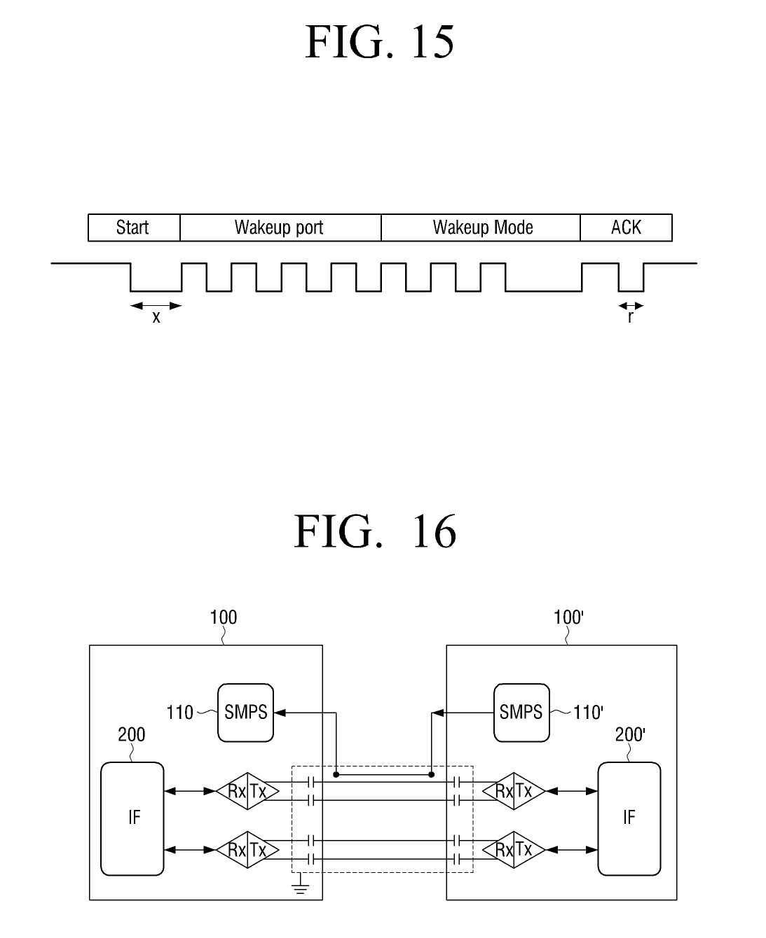

The microprocessor 120 can generate a wakeup initiation instruction to wake up the external device. More specifically, the microprocessor 120 can generate the wakeup initiation instruction to wake up the external device 10-1 according to a user's control command or according to an internal rule, and send the generated wakeup initiation instruction to the interface device 200. For example, when the media player device 100 is a DVD player and the user commands the media player device 100 to play a DVD through a remote control, the microprocessor 120 can generate the wakeup initiation instruction for the external device 10-1 and send the generated wakeup initiation instruction to the interface device 200 of the media player device 100 so as to wake up the external device 10-1 such as a DTV. The generated wakeup initiation instruction is described in more detail in FIG. 15.

When the external device 10-1 is rechargeable and is connected to the interface device 200, the microprocessor 120 can control the power unit 110 to supply the charge power to the external device 10-1. In detail, when the media player device 100 recognizes that the external device 10-1 connected via the interface device 200 is the rechargeable device, the microprocessor 120 can control the power unit 110 to supply the charge-mode power or the normal-mode power to the external device 10-1 through the interface device 200. When the charging is completed or the external device 10-1 is disconnected, the microprocessor 120 can cut off the power supply to the external device 10-1.

The user interface unit 130 includes a plurality of function keys allowing the user to define or select various functions supported by the media player device 100. The user interface unit 130 can be implemented using an input/output device such as touch pad, or by combining an input device such as keyboard, mouse, and wireless remote control, with an output device such as a liquid crystal display (LCD), a cathode ray tube (CRT), and speaker.

The user interface unit 130 can output contents of the media player device 100, or contents of the external devices 10-1 through 10-n transferred via the interface device 200.

When the connected external device 10-1 is charging, the user interface unit 130 can display the charge state of the corresponding external device 10-1.

The interface device 200 interconnects the media player device 100 and the external devices 10-1 through 10-2. The interface device 200 can be connected to the plurality of the external devices 10-1 through 10-n via the plurality of the cable connectors 300-1 through 300-n, and send an AV signal to the connected external devices 10-1 through 10-n. The interface device 200 can receive a wakeup signal or the wakeup initiation instruction from the external devices 10-1 through 10-n, send the wakeup signal to a particular external device to wake up the external device 10-1 through 10-n, or supply the charge power to charge the external device 10-1 through 10-n.

While the interface device 200 is connected to one external device 10-1 using one cable connector 300-1 in FIG. 1, the interface device 200 is connectable to the plurality of the external devices using the single cable connector when the cable connector is a 1:n cable connector.

Hereafter, the interface device 200 will be explained in more detail by referring to FIG. 2.

FIG. 2 is a detailed block diagram of the interface device 200 according to an exemplary embodiment.

The interface device 200 includes a communication interface 210, a controller 220, a plurality of acceptors 230, and a plurality of switches 240.

The communication interface 210 is formed to connect to the components of the media player device 100. The communication interface 210 sends and receives AV/signals and control signals to and from the components of the media player device 100, and receives the power from the power unit 110.

The controller 220 controls the components of the interface device 200. In detail, the controller 220 can detect whether the external devices 10-1 through 10-n are connected to the acceptors 230-1 through 230-n, and determine whether the connected external device 10 is rechargeable. When the external device 10 is rechargeable, the controller 220 provides the relevant information to the microprocessor 120 so as to charge the external device 10. In so doing, when the media player device 100 is in the standby mode, the controller 220 can send the wakeup signal to the microprocessor 120.

When the charging of the external device 10 is completed or when the external device 10 is disconnected, the controller 220 sends relevant information to the microprocessor 120 so as to finish the charge of the external device 10.

Upon receiving the wakeup initiation instruction for a particular external device 10-2 from the microprocessor 120, the controller 220 can determine to wake up the external device 10-2 based on the input wakeup initiation instruction, and send the wakeup signal via the acceptor 230-2 which is connected to the corresponding external device 10-2.

The controller 220 determines the interface type of the connected external device 10-2 and controls the switch 240 to select an appropriate interface type according to the determination. More specifically, the interface device 200 can send and receive data and control signals to and from the external device 10 according to a New InterFace (NIF) scheme and a conventional interface scheme (for example, Universal Serial Bus (USB), Micro-USB, Mobile High-definition Link (MHL), and Digital interface for Video and Audio (DiiVA).

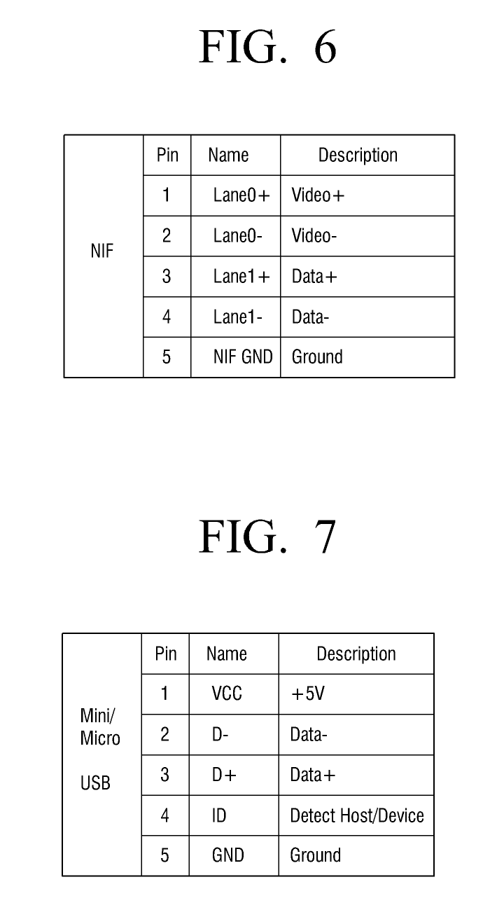

Herein, the NIF scheme provides the interface scheme with contact locations illustrated in FIG. 6. Hereinafter, the new interface is referred to as the NIF. The controller 200 determines whether the connected external device 10 conforms to the conventional interface scheme or the NIF scheme, and controls the switch 240 corresponding to the external device 10 to use the determined interface scheme.

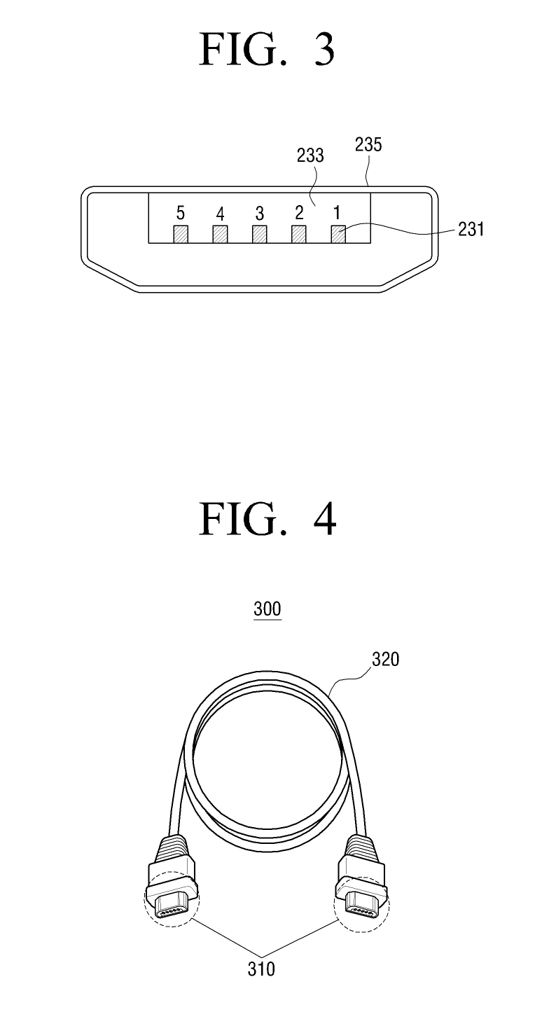

The acceptor 230 is connected to the external device 10 via the cable connector 300. In particular, the acceptor 230 can include a plurality of contact locations sequentially numbered. The contact locations 231 include a pin or a port electrically connected with a connector 310 of the cable connector 300. The acceptor 230 is illustrated in more detail in FIG. 3.

The switch 240, under control of the controller 220, switches to select the interface scheme corresponding to the interface type of the external device 10. While the plurality of the switches as many as the acceptors is provided in FIG. 2, some of the acceptors can be used only for a specific interface. In this case, the switch 240 can be equipped only for the acceptor which supports the multiple interfaces.

FIG. 3 is a detailed diagram of the acceptor of FIG. 2. Referring to FIG. 3, the acceptor 230 includes a plurality of contact locations 231, a support unit 233, and a metal support unit 235. The acceptor 230 is compatible with one of a Micro-USB connector, a mini USB connector, a USB connector, an MHL connector, and a DiiVA connector.

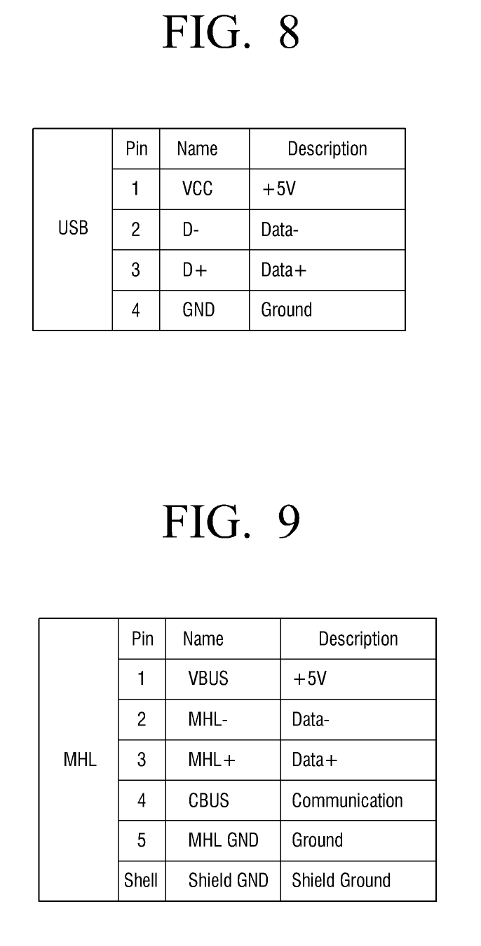

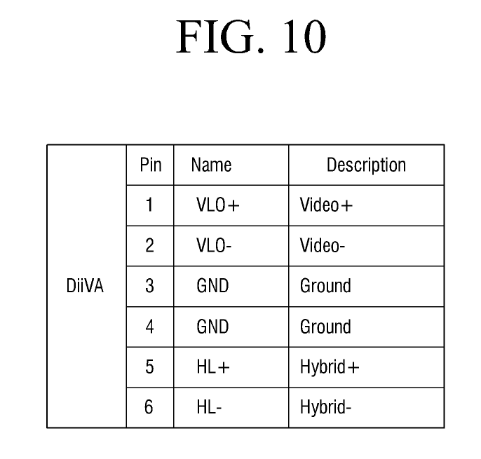

The contact locations 231 can have the same pin arrangement as the NIF shown in FIG. 6. The contact locations 231 are compatible with one of the Mini/Micro-USB interface of FIG. 7, the USB interface of FIG. 8, the MHL interface of FIG. 9, and the DiiVA interface of FIG. 10.

FIG. 4 depicts a cable connector according to an exemplary embodiment.

The cable connector 300 of FIG. 4 can be used to carry electrical signals between two media player devices 100 or between the media player device and the device. The cable connector 300 includes a cable 320 and connectors 310 disposed at both ends of the cable 320.

The cable 320 includes one or more signal lines inside its coating. When the cable connector 300 is connected between two devices, one or more signal lines in the cable 320 carry the electrical signal and the power between the two media player devices.

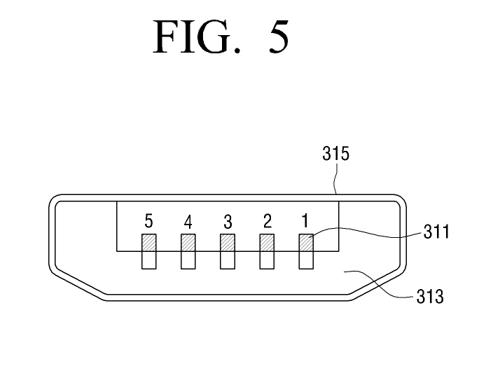

The connector 310 is formed at both ends of the cable 320. More specifically, the connector 310 can include a plurality of contact locations sequentially numbered. Herein, the contact location indicates the pin or the port electrically connected with the acceptor 230. The connector 310 shall be explained in detail by referring to FIG. 5.

While the connector 310 has the same shape and only one connector 310 is illustrated at each end of the cable 320 in FIG. 4, the connectors 310 can have different shapes at opposite ends of the cable. Additionally, one connector 310 can be formed in one side of the cable 320 and a plurality of connectors can be formed on the other side of the cable 320. Furthermore, it is possible to have multiple connectors 310 at each end of the cable 320.

FIG. 5 is a detailed diagram of the connector of FIG. 4.

The connector 310 of FIG. 5 includes a plurality of contact locations 311, and housings 313 and 315 for fixing and accommodating the contact locations 311. The connector 310 is compatible with one of the Micro-USB connector, the mini USB connector, the USB connector, the MHL connector, and the DiiVA connector.

The contact locations 311 can have the same pin arrangement as the NIF scheme of FIG. 6. The contact locations 311 are compatible with one of the Mini/Micro-USB interface of FIG. 7, the USB interface of FIG. 8, the MHL interface of FIG. 9, and the DiiVA interface of FIG. 10.

FIG. 6 depicts the NIF structure according to an exemplary embodiment.

More specifically, the interface according to an exemplary embodiment includes a plurality of pair contact location groups for sending data, and a ground contact location for grounding. Herein, the contact location group is a set of pins or ports for sending and receiving AV signals and control signals between a pair of the media player devices in a differential signaling manner. Herein, the differential signaling technique sends the pair of one signal and the other signal of the opposite phase.

Referring back to FIG. 6, the first and second contact locations (or ports) are the first pair contact location group for the first data transmission. In detail, the first pair contact location group includes a first pair plus contact location Lane0+ and a first pair minus contact location Lane0− for the differential signaling. The first pair plus contact location can correspond to the VCC contact location of the Micro-USB of FIG. 7, and the first pair minus contact location can correspond to the Data− contact location of the Micro-USB of FIG. 7. The first pair contact location group can be used for the wakeup process.

Referring back to FIG. 6, the third and fourth contact locations are the second pair contact location group for the second data transmission. The second pair contact location group includes a second pair plus contact location Lane1+ and a second pair minus contact location Lane1− for the differential signaling. With respect to FIG. 7, the second pair plus contact location can correspond to the Data+ contact location of the Mini/Micro-USB, and the second pair minus contact location can correspond to the ID contact location of the Mini/Micro-USB of FIG. 7. The second pair contact location group can be used to output the power for charging the external device.

The fifth contact location is the ground contact location for grounding. The ground contact location can correspond to the GND contact location of the NIF of FIG. 6 and the Mini/Micro-USB of FIG. 7.

As such, the NIF structure of FIG. 6 is compatible with the Mini/Micro-USB interface of FIG. 7, and supports the interface for transferring the data of both types.

Therefore, the contact locations of FIG. 6 are not only compatible with the Micro-USB, the contact locations of FIG. 6 can also be compatible with the USB interface of FIG. 8 and the MHL interface of FIG. 9.

In detail, when the contact locations of FIG. 6 are compatible with the USB interface of FIG. 8, the first pair plus contact location can correspond to the VCC contact location of the USB of FIG. 8 and the first pair minus contact location can correspond to the Data− contact location of the USB of FIG. 8. The second pair plus contact location can correspond to the Data+ contact location of the USB of FIG. 8 and the second pair minus contact location can correspond to the GNB contact location of the USB of FIG. 8.

When the contact locations of FIG. 6 are compatible with the MHL interface, the first pair plus contact location can correspond to the VBUS contact location of the MHL interface of FIG. 9 and the first pair minus contact location can correspond to the MHL− contact location of the MHL of FIG. 9. The second pair plus contact location can correspond to the MHL+ contact location of the MHL of FIG. 9 and the second pair minus contact location can correspond to the CBUS contact location of the MHL of FIG. 9. The ground contact location of FIG. 6 can correspond to the MHL GND contact location of the MHL of FIG. 9.

While the NIF includes five contact locations illustrated in FIG. 6, the NIF can have six contact locations including a power contact location for providing a particular power. The power contact location can be given the number ‘1’ or ‘6’.

In this case, the NIF is compatible with the DiiVA interface of FIG. 10.

More specifically, when the power contact location is numbered ‘6’, the first pair plus contact location can correspond to the VLO+ contact location of the DiiVA of FIG. 10 and the first pair minus contact location can correspond to the VLO− contact location of the DiiVA of FIG. 10. The second pair plus contact location can correspond to the GND contact location of the DiiVA of FIG. 10 and the second pair minus contact location can correspond to the GND contact location of the DiiVA of FIG. 10. The ground contact location can correspond to the HL+ contact location of the DiiVA of FIG. 10, and the power contact location can correspond to the HL− contact location of the DiiVA of FIG. 10.

When the power contact location is numbered ‘1’, the first pair plus contact location can correspond to the VLO− contact location of the DiiVA of FIG. 10 and the first pair minus contact location can correspond to the GND contact location of the DiiVA of FIG. 10. The second pair plus contact location can correspond to the GND contact location of the DiiVA of FIG. 10 and the second pair minus contact location can correspond to the HL+ contact location of the DiiVA of FIG. 10. The ground contact location can correspond to the HL− contact location of the DiiVA of FIG. 10, and the power contact location can correspond to the VLO+ contact location of the DiiVA of FIG. 10.

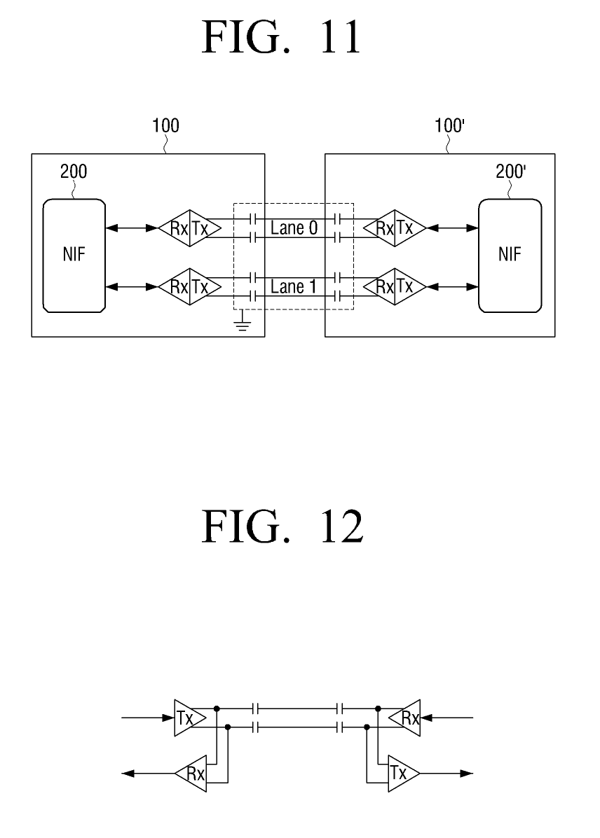

FIG. 11 depicts a method for sending and receiving data according to the NIF structure according to an exemplary embodiment.

In FIG. 11, the NIF structure includes two lanes, and sends and receives one Audio/Video/Data (A/V/D) through one lane. More specifically, the NIF can transceive first data over the first lane and second data over the second lane. The first lane can carry the wakeup signal and the second lane can supply the charge power to the external device. That is, the NIF can send the A/V/D at the same time as charging the external device. The detailed lane structure is shown in FIG. 12.

While one lane structure of FIGS. 11 and 12 performs the two-way communication, the lane structure can be implemented to perform the one-way communication.

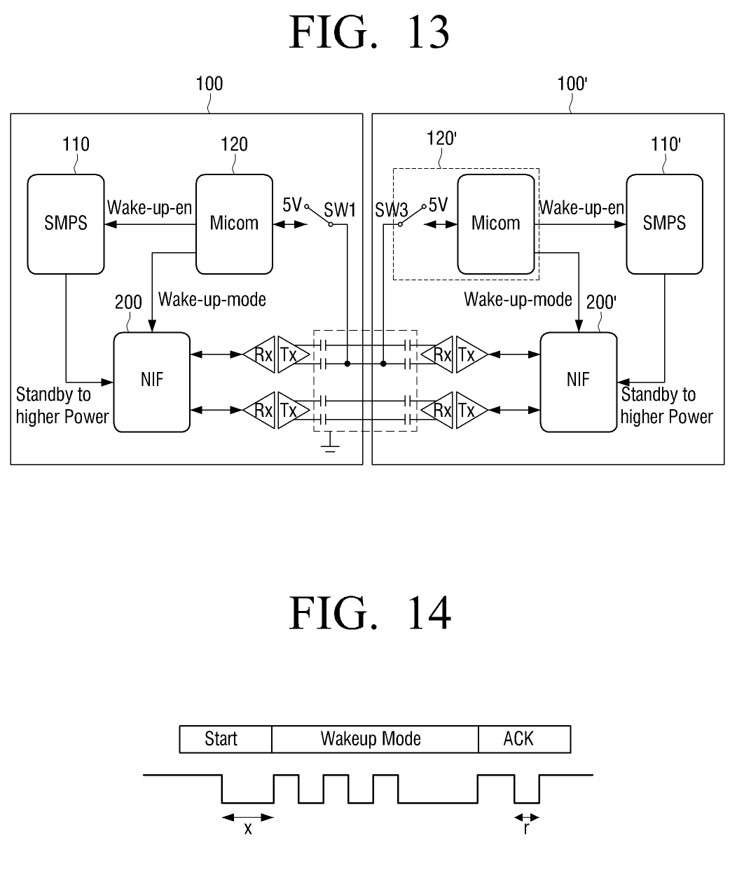

FIG. 13 illustrates a method for waking up the media player device through the NIF according to an exemplary embodiment.

Referring to FIG. 13, the interface device 200 can be connected to the external device (including a portable device) 100′ through the cable connector, and can detect the connection to the external device 100′ using one of the contact locations of the connector. The interface device 200 can determine whether the external device 100′ is rechargeable, using the first pair minus contact location of the connected contact locations. When the corresponding device is rechargeable, the interface device 200 can notify the microprocessor 120 of the rechargeable device connection. While the interface device 200 recognizes the connection of the external device 100′, the microprocessor 120 can directly recognize the connection of the external device 100′ by detecting a signal from one of the contact locations as shown in FIG. 13.

When the media player device 100 is in the standby mode, the interface device 200 can send the wakeup signal to the microprocessor 120. The microprocessor 120 receiving the wakeup signal or the signal informing of the rechargeable device connection can control the power unit 110 to output the power according to the wakeup mode of the wakeup signal. When the power unit 110 outputs the power according to the wakeup mode, the interface device 200 can supply the corresponding power to the external device 100′ using one of the pair contact location groups.

While the external device 100′ is charged using one pair contact location illustrated in FIG. 13, the power can be supplied to the external device 100′ using a separate power contact location as shown in FIG. 16. That is, the power location configuration of FIG. 10 can be used to supply the power to the external device. Alternatively, the power can be supplied to the external device 100′ using both of the two pair contact location groups, or using one pair contact location group and the power contact location. That is, a plurality of lines can be used to supply more current to the external device 100′.

In FIG. 13, when the external device 100′ is connected, the wakeup is immediately carried out to supply the charge power to the external device. In this configuration, the wakeup can be carried out and the charge power can be supplied to the external device when the wakeup signal is received from the external device 100′.

Now, the wakeup of the external device 100′ is explained by referring to FIG. 13.

When the external device 100′ needs to wake up, the microprocessor 120 can send the wakeup initiation instruction illustrated in FIG. 15 to wake up the relevant external device 100′ to the interface device 200. Herein, the wakeup initiation instruction includes a start field indicating the start of the wakeup instruction, a wakeup port field indicating the device to wake up, a wakeup mode field indicating the mode of the wakeup, and an ACK field.

The interface device 200 receiving the wakeup initiation instruction can determine the external device to wake up based on the wakeup port field of the received wakeup initiation instruction, and send the wakeup signal illustrated in FIG. 14 to the acceptor connected to the corresponding external device, that is, to the corresponding external device. Herein, the wakeup signal can include the start field indicating the start of the wakeup instruction, the wakeup mode field indicating the mode of the wakeup, and the ACK field, without the wakeup port field of the wakeup initiation instruction.

The interface device 200 can send the wakeup signal to the external device 100′ using the first pair contact location group of the contact locations. Alternatively, the interface device 200 can send the wakeup signal to the external device 100′ using only one contact location.

So far, while the media player device 100 generates and sends the wakeup initiation instruction for the particular external device, the wakeup initiation instruction can be received from the external device 100′.

For example, upon receiving the wakeup initiation instruction for the external device 10-2 from the external device 10-1, the interface device 200 can determine the external device to wake up based on the wakeup port field of the input wakeup initiation instruction and send the wakeup signal to the determined external device.

FIG. 14 depicts the wakeup signal according to an exemplary embodiment.

The wakeup signal of FIG. 14 can include the start field, the wakeup mode field, and the ACK field.

The start field, which informs of the start of the wakeup instruction, can be a signal which falls from the high level to the low level and is sustained for a preset time “x”. In this configuration, the start field may employ the signal which rises from the low level to the high level and then is sustained for a preset time.

The wakeup mode field, which indicates the mode of the wakeup, can include a plurality of wakeup modes (Wakeup 1 step, Wakeup 2 step, and Wakeup 3 step) corresponding to the operation modes of the media player device (or the portable device), and a charge mode (Charging only).

The ACK field is used by the external device 100′ receiving the wakeup signal for a preset time “r” to inform the interface device 200 sending the wakeup signal of the reception of the wakeup signal.

FIG. 15 depicts the wakeup initiation instruction according to an exemplary embodiment.

The wakeup initiation instruction of FIG. 15 includes the start field, the wakeup port field, the wakeup mode field, and the ACK field.

The start field, which informs of the start of the wakeup instruction, can be a signal which falls from the high level to the low level and is sustained for a preset time “x”. The start field may employ a signal which rises from the low level to the high level and is then sustained for a preset time.

The wakeup port field signals the external device to wake up.

The wakeup mode field, which signals the mode of the wakeup, can include a plurality of wakeup modes (Wakeup 1 step, Wakeup 2 step, and Wakeup 3 step) corresponding to the operation modes of the media player device (or the portable device), and a charge mode (Charging only).

The ACK field is used by the external device 100′ receiving the wakeup signal to inform the interface device 200 sending the wakeup signal of the reception of the wakeup signal.

FIG. 16 illustrates a method of the media player device for charging the external device through the NIF including 6 pins.

Referring to FIG. 16, the power is supplied to the external device 100′ through the power contact location of the six contact locations. While the power is supplied to the external device 100′ through only the power contact location, the power supply can be carried out using the power contact location and the additional pair contact location group in the implementation.

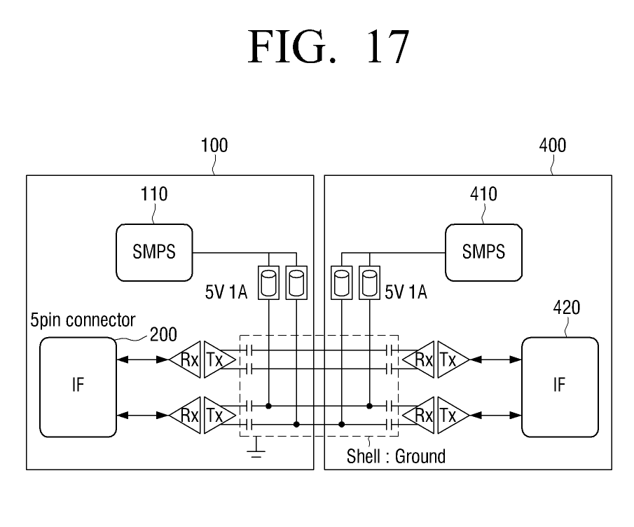

FIG. 17 illustrates a method of the media player device for charging the external device through the NIF including 5 pins.

Referring to FIG. 17, the power is supplied to the external device through the second pair contact location group of the five contact locations. While the power is supplied using the pair contact location group of FIG. 17, the power supply to the external device 100′ can be carried out using only one contact location of the pair contact location group in this configuration.

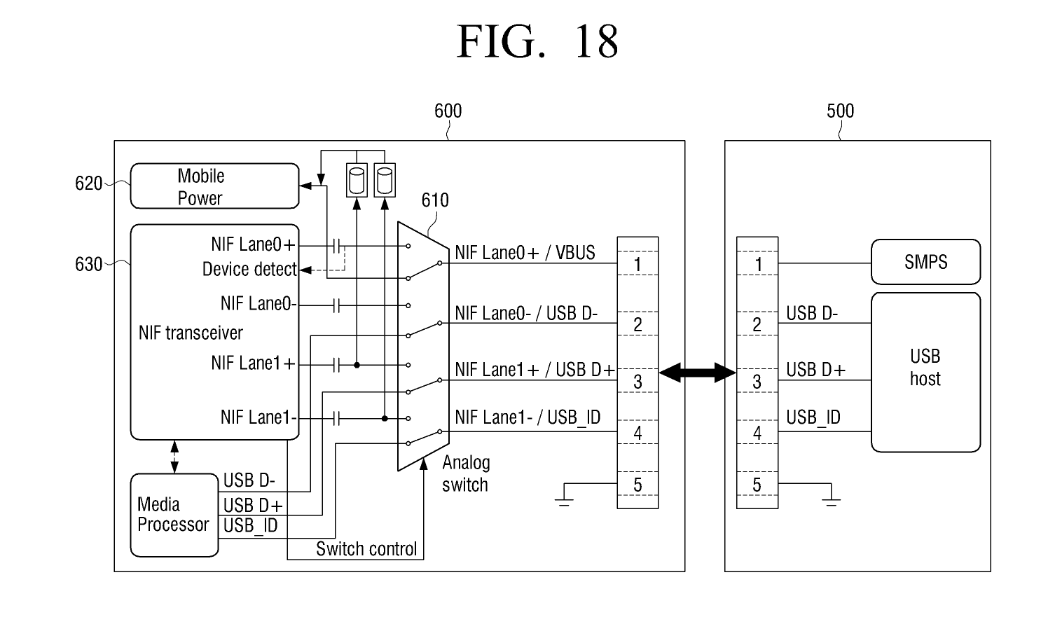

FIG. 18 illustrates operations of the interface device 200 when the media player device 600 is connected to a device 500 including the Micro-USB interface according to an exemplary embodiment.

When the media player device 600 is connected to the external device 500 including the Micro-USB interface as shown in FIG. 18, the controller 630 corresponding to the controller 220 of FIG. 2 can detect that the connected external device 500 conforms to the USB interface scheme, and output the control signal to the switch 610 corresponding to the switch 240 of FIG. 2 to interface with the external device 500 in the USB interface scheme. At this time, the media player device 600 can receive the charge power through the second pair contact location of the multiple contact locations.

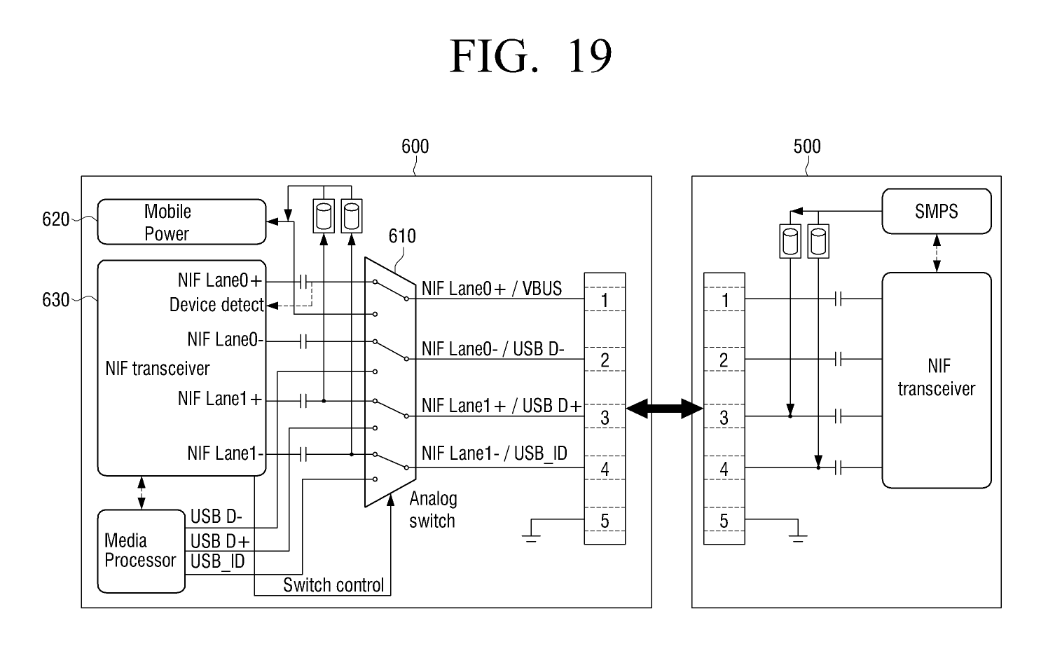

FIG. 19 illustrates operations of the interface device 200 when the media player device 600 is connected to a device 500 including the NIF according to an exemplary embodiment.

When the media player device 600 is connected to the external device 500 including the NIF interface as shown in FIG. 19, the controller 630 corresponding to the controller 220 of FIG. 2 can detect that the connected external device 500 conforms to the NIF scheme, and output the control signal to the switch 610 corresponding to the switch 240 of FIG. 2 to interface with the external device 500 in the NIF manner. At this time, the media player device 600 can receive the charge power through the second pair contact location of the multiple contact locations.

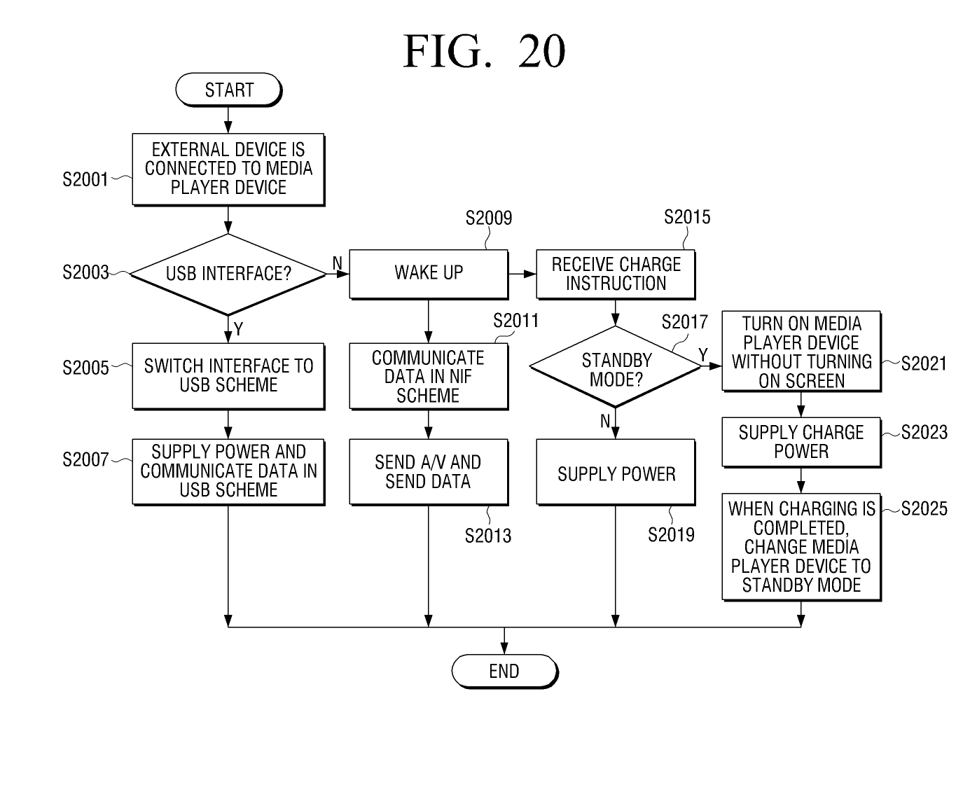

FIG. 20 is a flowchart of a method for charging the external device connected to the media player device with different interfaces according to an exemplary embodiment.

When the external device is connected to the media player device (S2001), the method determines whether the connected external device conforms to the Micro-USB interface scheme or the NIF scheme (S2003).

When determined that the connected external device conforms to the Micro-USB interface scheme (S2003-Y), the switch 240 of the interface device 200 interfaces according to the Micro-USB interface scheme (S2005). Next, in the Micro-USB interface scheme, the charge power can be supplied to or data can be communicated with the external device (S2007).

By contrast, when the connected external device conforms to the NIF scheme (S2003-N), the media player device (S2009) is awaken.

Next, the method communicates data according the NIF scheme (S2011) and transfers AN and data according to the NIF scheme (S2013).

When the charge instruction is received after the wakeup (S2015), the method determines whether the media player device is in the standby mode (S2017).

When the media player device is in the normal mode, rather than the standby mode, the charge power is supplied to the external device (S2019).

When the media player device is in the standby mode, the method turns on the media player device without turning on a screen of the media player device (S2021) and supplies the charge power to the external device (S2023). Next, when the charging is completed, the media player device switches back to the standby mode (S2025).

FIG. 20 illustrates the method of determining whether the connected external device complies with the Micro-USB interface scheme or the NIF scheme. However, the interface device is compatible with other interface schemes, such as the USB interface scheme of FIG. 8, the MHL interface scheme of FIG. 9, and the DiiVA interface scheme of FIG. 10.

The foregoing exemplary embodiments and advantages are merely exemplary and are not to be construed as limiting the present inventive concept. The present teaching can be readily applied to other types of apparatuses. Also, the description of the exemplary embodiments of the present inventive concept is intended to be illustrative, and not to limit the scope of the claims, and many alternatives, modifications, and variations will be apparent to those skilled in the art.

What is claimed is:

1. A connector for connecting an electronic device to an external device, the connector comprising:
a plurality of contact locations which are sequentially numbered; and
a housing which accommodates the plurality of contact locations,
wherein the plurality of contact locations comprise:
a first pair contact location group configured for a first data transmission, and
a second pair contact location group configured for a second data transmission.

2. The connector of claim 1, wherein the first pair contact location group comprises a first pair plus contact location and a first pair minus contact location for differential signaling.

3. The connector of claim 1, wherein the connector is compatible with at least one of a Micro-Universal Serial Bus (USB) connector, a mini USB connector, a USB connector, a Mobile High-Definition Link (MHL) connector, and a Digital interface for Video and Audio (DiiVA) connector.

4. The connector of claim 1, wherein the connector is at least one of a 5-pin connector and a 6-pin connector.

5. The connector of claim 1, wherein the plurality of contact locations further comprise:
a ground contact location for connecting to ground.

6. The connector of claim 5, wherein the first pair contact location group is numbered as 1 and 2,
the second pair contact location group is numbered as 3 and 4, and
the ground contact location is numbered as 5.

7. The connector of claim 5, wherein the connector is compatible with a Micro-Universal Serial Bus (USB) connector, and
a first pair plus contact location of the first pair contact location group of the connector corresponds to a VCC contact location of the Micro-USB connector,
a first pair minus contact location of the first pair contact location group of the connector corresponds to a DATA− contact location of the Micro-USB connector,
a second pair plus contact location of the second pair contact location group of the connector corresponds to a DATA+ contact location of the Micro-USB connector,
a second pair minus contact location of the second pair contact location group of the connector corresponds to an identifier (ID) contact location of the Micro-USB connector, and
the ground contact location of the connector corresponds to a GND contact location of the Micro-USB connector.

8. The connector of claim 5, wherein the connector is compatible with a Universal Serial Bus (USB) connector, and
a first pair plus contact location of the first pair contact location group of the connector corresponds to a VCC contact location of the USB connector,
a first pair minus contact location of the first pair contact location group of the connector corresponds to a DATA− contact location of the USB connector,
a second pair plus contact location of the second pair contact location group of the connector corresponds to a DATA+ contact location of the USB connector, and
a second pair minus contact location of the second pair contact location group of the connector corresponds to a GND contact location of the USB connector.

9. The connector of claim 5, wherein the connector is compatible with a Mobile High-Definition Link (MHL) connector, and
a first pair plus contact location of the first pair contact location group of the connector corresponds to a VBUS contact location of the MHL connector,
a first pair minus contact location of the first pair contact location group of the connector corresponds to an MHL− contact location of the MHL connector,
a second pair plus contact location of the second pair contact location group of the connector corresponds to an MHL+ contact location of the MHL connector,
a second pair minus contact location of the second pair contact location group of the connector corresponds to a CBUS contact location of the MHL connector, and
the ground contact location of the connector corresponds to an MHL GND contact location of the MHL connector.

10. The connector of claim 5, wherein the contact locations further comprise:
a power contact location for providing power.

11. The connector of claim 10, wherein the connector is compatible with a DiiVA connector, and
the first pair contact location group of the connector corresponds to a VLO contact location of the DiiVA connector,
the second pair contact location group of the connector corresponds to a GND contact location of the DiiVA connector,
the ground contact location of the connector corresponds to a HL+ contact location of the DiiVA connector, and
the power contact location of the connector corresponds to a HL− contact location of the DiiVA connector.

12. An interface device for interfacing an electronic device with an external device, the interface device comprising:
a plurality of contact locations which are sequentially numbered; and
an acceptor which accommodates the plurality of contact locations,
wherein the plurality of contact locations comprise:
a first pair contact location group configured for a first data transmission, and
a second pair contact location group configured for a second data transmission.

13. The interface device of claim 12, wherein the first pair contact location group comprises a first pair plus contact location and a first pair minus contact location for differential signaling.

14. The interface device of claim 12, wherein the acceptor is at least one of a Micro-Universal Serial Bus (USB) acceptor, a mini USB acceptor, a USB acceptor, a Mobile High-Definition Link (MHL) acceptor, and a Digital interface for Video and Audio (DiiVA) acceptor.

15. The interface device of claim 12, wherein the acceptor is at least one of a 5-pin acceptor and a 6-pin acceptor.

16. The interface device of claim 12, wherein the plurality of contact locations further comprise:
a ground contact location for connecting to ground.

17. The interface device of claim 16, wherein the first pair contact location group is numbered as 1 and 2,
the second pair contact location group is numbered as 3 and 4, and
the ground contact location is numbered as 5.

18. The interface device of claim 16, wherein the acceptor is compatible with a Micro-Universal Serial Bus (USB) acceptor, and
a first pair plus contact location of the first pair contact location group of the interface device corresponds to a VBUS contact location of the Micro-USB acceptor,
a first pair minus contact location of the first pair contact location group of the interface device corresponds to a DATA− contact location of the Micro-USB acceptor,
a second pair plus contact location of the second pair contact location group of the interface device corresponds to a DATA+ contact location of the Micro-USB acceptor,
a second pair minus contact location of the second pair contact location group of the interface device corresponds to an identifier (ID) contact location of the Micro-USB acceptor, and
the ground contact location of the interface device corresponds to a GND contact location of the Micro-USB acceptor.

19. The interface device of claim 16, wherein the acceptor is compatible with a USB acceptor,
a first pair plus contact location of the first pair contact location group of the interface device corresponds to a VCC contact location of the USB acceptor,
a first pair minus contact location of the first pair contact location group of the interface device corresponds to a DATA− contact location of the USB acceptor,
a second pair plus contact location of the second pair contact location group of the interface device corresponds to a DATA+ contact location of the USB acceptor, and
a second pair minus contact location of the second pair contact location group of the interface device corresponds to a GND contact location of the USB acceptor.

20. The interface device of claim 16, wherein the acceptor is compatible with Mobile High-Definition Link (MHL) acceptor, and
a first pair plus contact location of the first pair contact location group of the interface device corresponds to a VBUS contact location of the MHL acceptor,
a first pair minus contact location of the first pair contact location group of the interface device corresponds to an MHL− contact location of the MHL acceptor,
a second pair plus contact location of the second pair contact location group of the interface device corresponds to an MHL+ contact location of the MHL acceptor,
a second pair minus contact location of the second pair contact location group of the interface device corresponds to a CBUS contact location of the MHL acceptor, and
the ground contact location of the interface device corresponds to an MHL GND contact location of the MHL acceptor.

21. The interface device of claim 16, wherein each of the plurality of contact locations further comprises:
a power contact location which provides power.

22. The interface device of claim 21, wherein the acceptor is compatible with a Digital interface for Video and Audio (DiiVA) acceptor,
the first pair contact location group of the interface device corresponds to a VLO contact location of the DiiVA acceptor,
the second pair contact location group of the interface device corresponds to a GND contact location of the DiiVA acceptor,
the ground contact location of the interface device corresponds to a HL+ contact location of the DiiVA acceptor, and
the power contact location of the interface device corresponds to a HL− contact location of the DiiVA acceptor.

23. The interface device of claim 12, wherein the interface device sends and receives a wakeup signal, which wakes up the interface device from a standby mode, to and from the external device.

24. The interface device of claim 23, wherein the first pair contact location group sends and receives the wakeup signal to and from the external device.

25. The interface device of claim 23, wherein the wakeup signal comprises a start field indicating start of a wakeup instruction, a wakeup mode field indicating a wakeup mode, and an acknowledgement field.

26. The interface device of claim 25, wherein the wakeup mode comprises a plurality of wakeup modes corresponding to a plurality of operation modes of the external device respectively, and a charge mode.

27. The interface device of claim 12, wherein the interface device sends and receives power to and from the external device using two or more of the contact locations.

28. The interface device of claim 27, wherein the second pair contact location group of the interface device sends and receives the power.

29. The interface device of claim 12, wherein the interface device is connected to a plurality of external devices with a single cable connector when the cable connector is a 1:n cable connector, wherein n is a natural number greater than or equal to 1.

30. The interface device of claim 12, further comprising:
a controller which determines an interface type of the external device; and
a switch which selects the interface type of the external device according to the determination of the controller.

31. A cable connector for connecting an electronic device to at least one external device, the cable connector comprising:
a cable having a first end connected to a first connector and a second end opposite to the first end connected to a second connector,
wherein each of the first and second connectors comprise
a plurality of contact locations sequentially numbered; and
a housing which accommodates the plurality of contact locations,
wherein the plurality of contact locations comprise:
a first pair contact location group utilized for a first data transmission, and
a second pair contact location group utilized for a second data transmission.

32. The cable connector of claim 31, wherein the first and second connectors have a same shape.

33. The cable connector of claim 31, wherein the first and second connectors have different shapes.

34. The cable connector of claim 31, wherein the second connector comprises a plurality of connectors.
